(19) United States
(12) Patent Application Publication
(10) Pub. No.: US 2009/0190029 A1
(43) Pub. Date: Jul. 30, 2009

(54) VIDEO PROCESSING METHODS AND RELATED APPARATUS

(76) Inventors: Te-Hao Chang, Taipei City (TW); Siou-Shen Lin, Taipei County (TW); Chin-Chuan Liang, Taichung City (TW); I-Pu Niu, Taichung City (TW); Po-Wei Chao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/020,592

(22) Filed: Jan. 28, 2008

(51) Int. Cl. H04N 7/01

(52) U.S. Cl. 348/452; 348/E07.003

(57) ABSTRACT

A video processing method includes: executing a first video detection for a first video processing operation; and performing a second video processing operation by referencing detection result of the first video detection. One of the first and second video processing operations is line-based processing, and the other is block-based processing.

### BACKGROUND

The present invention relates to a video processing scheme, and more particularly to video processing methods and related apparatuses for performing different video processing operations based on scan lines and blocks.

In general, a conventional video processing apparatus comprises a de-interlace processing module for converting an interlaced video into a progressive video. In order to correctly process the interlaced video, the de-interlace processing module needs to execute video detection, such as a motion detection or a film mode detection, before converting the interlaced video into progressive video. To cancel motion judder effects, a motion compensation module is used for processing the progressive video to cancel judder artifacts therein. The motion compensation module also execute video detection, e.g. the above-mentioned motion detection and film mode detection, to acquire information used to cancel motion judder artifacts. De-interface is typically processed line by line, so the above-mentioned video detection executed by a de-interlace processing module is usually a line-based video detection. Motion compensation on the other hand is typically processed block by block, and thus video detection executed by a motion compensation module is usually a block-based video detection.

More particularly, the de-interlace processing module converts interlaced video having a string of interlaced top and bottom fields into progressive video. The interlaced video may be a normal video or a film mode video, the de-interlace processing module executes video detection in order to process the interlaced video according to detection results. Regarding the motion compensation module, in general, a movie, film mode video, or an animation has a sampling rate of approximately 24-30 frames per second. However, the display frame rate of a display device is usually 50-60 frames per second or higher. Thus, the motion compensation module converts the progressive video having a lower frame rate (e.g. 30 frames per second) into a progressive video having a higher frame rate (e.g. 60 frames per second) for displaying on a common display device. Conventional frame rate conversion is achieved by duplicating certain frames of the original progressive video. For instance, when converting a video having 30 frames per second into a video having 60 frames per second, a duplication of each frame is immediately interpolated into the original video. In another example, converting a video having 24 frames per second into a video having 60 frames per second is more complex since some frames are repeated twice while other frames are repeated only once. In some cases, a progressive video outputted from the de-interlace module may have 60 frames per second, where the progressive video is generated inherently by repeating frames in an original video of 24/30 Hz. Although videos inputted to and outputted from the motion compensation module have 60 frames per second, the motion compensation module needs to execute film mode detection upon the progressive video and then uses the result of film mode detection to recover the original video of 24/30 Hz from the progressive video. Afterwards, the motion compensation module performs corresponding operation to achieve frame rate conversion according to the recovered video. The definition of motion compensation is usually referred as to “Motion Compensated Frame rate conversion and Film mode detection/recovery”, i.e. motion judder cancellation.

Motion judder effects are the consequence due to the above-described duplications. The so-called motion judder effects refer to unsmooth motion of object across frames. Please refer to FIG. 1. FIG. 1 is a diagram illustrating examples of converting an original video into a video being displayed on a display device with a higher frame rate by duplicating frames and by interpolating frames generated by a motion compensation module respectively. As shown in FIG. 1, frames F₁′ and F₂′ are duplications of frames F₁ and F₂ respectively, and frames F₁″ and F₂″ are interpolated frames, which are generated using the above-mentioned motion compensation operation. When displaying a video having duplicated frames, viewers may perceive some motion judder effects due to non-smooth motion of an object (e.g. the airplane shown in FIG. 1).

### SUMMARY

An objective of the present invention is to provide a video processing method and related apparatus for sharing information of line-based and block-based detection results to decrease the computation amount and to achieve more robust video detection.

According to an embodiment of the present invention, a video processing method comprises conducting a first video detection for a first video processing operation; and performing a second video processing operation with reference to a detection result of the first video detection; wherein one of the first and second video processing operation is a line-based processing, and the other is a block-based processing. In some other embodiments, the method further comprising conducting a second video detection for the second video processing operation, thereby the second video processing operation is executed by referring to either or both the detection results of first video detection and second video detection. The first video processing operation of one embodiment refers to either or both the detection results of first video detection and second video detection.

In some embodiments, the video processing method comprises determining a target detection result according to the detection results of first video detection and second video detection, and performing the first video processing operation according to the target detection result.

According to an embodiment of the present invention, a video processing apparatus comprises a first video processing module and a second video processing module. The first video processing module comprises a first video detector, and processes a video signal with reference to a detection result of the first video detector. The second video processing module is coupled to the first video processing module and receives the detection result of the first video detector as information for processing the video signal. One of the first and second video processing modules is operated in a line-based detection, and the other is operated in a block-based detection. In some embodiments, the second video processing module comprises a second video detector and the second video processing module also refers to the detection result of the second video detector.

Some other embodiments of the video processing apparatus comprise a first video processing module, a second video processing module, and an arbiter. The first video processing module executes a first video detection for a first video processing operation. The second video processing module is coupled to the first video processing module and executes a second video detection for second video processing operation. The arbiter is coupled to the first video processing module and the second video processing module and is utilized for determining a target detection result according to detection results of the first and second video processing modules. The first video processing module performs the first video processing operation with reference to the target detection result. In an embodiment, the second video processing module performs the second video processing operation with reference to the target detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating two examples of converting an original video into a video being displayed on a display device by duplicating frames and by utilizing a motion compensation module respectively.

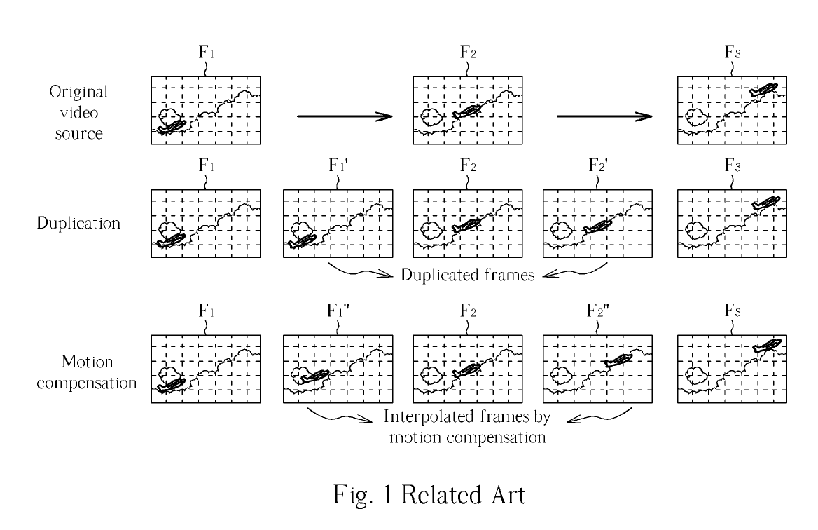

FIG. 2 is a block diagram of a video processing apparatus according to a first embodiment of the present invention.

FIG. 3 is a block diagram of a video processing apparatus according to a second embodiment of the present invention.

FIG. 4 is a block diagram of a video processing apparatus according to a third embodiment of the present invention.

FIG. 5 is a block diagram of a video processing apparatus according to a fourth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

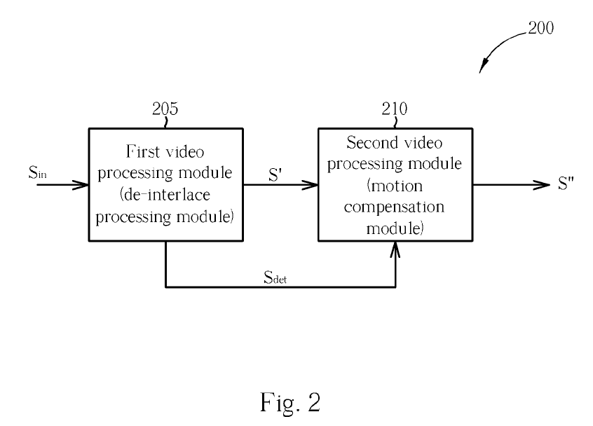

Please refer to FIG. 2. FIG. 2 is a block diagram of a video processing apparatus 200 according to a first embodiment of the present invention. The video processing apparatus 200 comprises a first video processing module 205 and a second video processing module 210. In this embodiment, the first and second video processing modules 205 and 210 are de-interlace processing module and motion compensation module respectively. In order to apply de-interlace to the input video signal Sᵢₙ, the first video processing module 205 executes a first video detection. The second video processing module 210 utilizes a detection result S_{det} of the first video detection as a reference for a second video processing operation (i.e. motion compensation operation). In some embodiments, the second video processing module 210 still executes video detection, and the detection result S_{det} is used as additional reference information for motion compensation, and in some other embodiments, the second video processing module 210 reduce computational complexity of video detection by simplifying or skipping one or more detection types or detection steps. In this embodiment, de-interface processing module 205 processes interlaced video signal Sᵢₙ by line-based processing and motion compensation module 210 processes progressive video signal S′ by block-based processing. Embodiments of video detections include motion detections such as detection of motion vector, motion direction, still or motion, and film mode detections such as detection of video mode or film mode.

As shown in FIG. 2, taking the film mode detection as an example, de-interface processing module 205 receives an interlaced video signal Sᵢₙ and generates a progressive video signal S′ in accordance with a film mode detection result S_{det}. Motion compensation module 210 receives the progressive video signal S′ and performs the motion compensation operation according to the film mode detection result S_{det} received from de-interlace processing module 205 without executing block-based film mode detection. Motion compensation module 210 outputs an progressive video signal S″ for displaying on a display device with suppressed motion judder effects. For example, if de-interlace processing module 205 detects that the interlaced video signal Sᵢₙ is generated from a film mode video, the detection result S_{det} indicates that the interlaced video signal Sᵢₙ is a film mode video signal and it may also carry pull-down sequences. Motion compensation module 210 interpolates the progressive video signal S′ according to the detection result S_{det} in a manner of suppressing motion judder effects. It is advantageous for motion compensation module 210 to directly utilize or merely refer to the detection result S_{det} sent from de-interlace processing module 205, as time computing power for executing video detection can be saved. In addition, in general, a conventional motion compensation module needs to read data from a memory (e.g. DRAM) storing pixels and write data into the memory for film mode detection, the motion compensation module 210, however, only writes data into a memory by using/referencing the detection result S_{det} mentioned above without reading data from the memory. Bandwidth of the memory can be more efficiently used.

Similarly, taking motion detection as another example, de-interlace module 205 executes a line-based motion detection for de-interlacing the interlaced video signal Sᵢₙ to generate the progressive video signal S′, and motion compensation module 210 utilizes or refers to the detection result of the line-based motion detection executed by de-interlace processing module 205. The detection result S_{det} can comprise data such as information indicating the video signal Sᵢₙ is a normal video signal/film mode video signal, information indicating the frame is a still/motion frame, information regarding motion directions, or any information that can be retrieved by de-interlace processing module and is useful for motion compensation module 210.

In some examples, instead of directly utilizing the detection result S_{det} without executing video detection, the second video processing module 210 executes video detection with reference to the detection result S_{det} received from the first video processing module 205 for the second video processing operation. For example, the second video processing module 210 references the detection result S_{det} of the first video detection (e.g. the line-based video detection) to adjust a decision threshold of entering/exiting a film mode or to dynamically adjust a decision threshold for motion detection, for executing the second video detection (e.g. the block-based video detection). For instance, if the detection result S_{det} indicates the interlaced video signal Sᵢₙ changes into a film mode video signal from a normal video signal or the interlaced video signal Sᵢₙ is a film mode video signal, the second video processing module 210 decreases the decision threshold of entering the film mode or increases the decision threshold of exiting the film mode when executing the second video detection, so as to enter or remain in film mode more easily. Otherwise, if the detection result S_{det} indicates the interlaced video signal Sᵢₙ changes into a normal video signal from a film mode video signal or the interlaced video signal Sᵢₙ is a normal video signal, the second video processing module 210 decreases the decision threshold of exiting the film mode when executing the second video detection, so as to enter the normal mode more easily. Similarly, taking the motion detection as an example, if the detection result S_{det} indicates the interlaced video signal Sᵢₙ is a motion video signal, motion compensation module 210 decreases the decision threshold for motion detection when executing the block-based motion detection, so as to increase the probability that the progressive video signal S′ is identified as a motion video signal. Otherwise, if the detection result S_{det} indicates the interlaced video signal Sᵢₙ is a still video signal, the second video processing module 210 increases the decision threshold for motion detection when executing the block-based motion detection, so as to increase the probability that the progressive video signal S′ is identified as a still video signal. An advantage is that conflict situations where two modules came up with different detection results can be reduced, for example, in a case when one of the interlaced video signal Sᵢₙ and progressive video signal S′ is identified as a film mode video signal while the other is identified as a normal video signal. The performance of the video processing apparatus 200 therefore becomes more reliable with greater noise robustness.

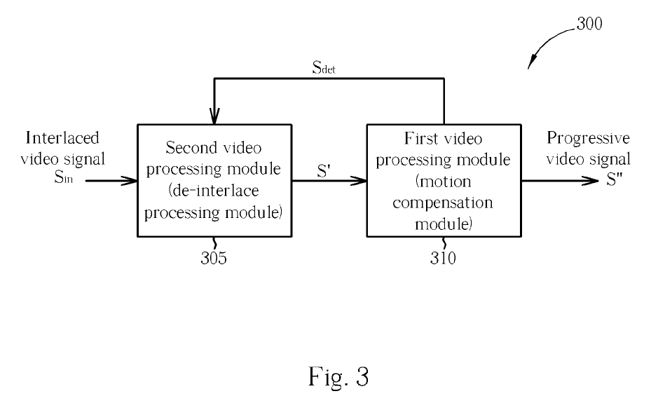

Additionally, in another embodiment, a first video processing module such as de-interlace processing module can also utilize a detection result of a second video processing module such as motion compensation module without executing all or a part of video detection, to perform de-interlace operation. Please refer to FIG. 3. FIG. 3 is a block diagram of a video processing apparatus 300 according to a second embodiment of the present invention. In this embodiment, a first video processing module 310 is a motion compensation module, and a second video processing module 305 is a de-interlace processing module. Please note that, typically, the second video processing module 305 initially executes video detection in order to correctly convert an interlaced video signal Sᵢₙ to a progressive video signal S′. However, once the first video processing module 310 outputs a detection result S_{det}′ of the motion detection/film mode detection, the second video processing module 305 can directly utilize the detection result S_{det}′ without executing a second video detection (i.e. a line-based motion detection/film mode detection), for performing the de-interlace operation. Further descriptions regarding the de-interlace operation and motion compensation operation are omitted for brevity. Similarly, the detection result S_{det}′ may comprise information such as information indicating the video signal Sᵢₙ is a normal video signal/film mode video signal, information indicating the frame is a still/motion frame, or information regarding motion directions, which is useful for the second video processing module 210.

Instead of directly utilizing the detection result S_{det}′ without executing the second video detection (i.e. the line-based video detection), the second video processing module 305 can also execute the second video detection with reference to the detection result S_{det}′ of the first video detection. Specifically, the second video processing module 305 references the detection result S_{det}′ of the first video detection (i.e. the block-based video detection) to adjust a decision threshold of entering/exiting a film mode or to dynamically adjust a decision threshold for motion detection. For example, if the detection result S_{det}′ determines the progressive video signal S′ changes into a film mode video signal from a normal video signal or the progressive video signal S′ is still a film mode video signal, the second video processing module 305 decreases the decision threshold of entering the film mode or increases the decision threshold of exiting the film mode when executing the second video detection, so as to enter or remain in film mode more easily. Otherwise, if the detection result S_{det}′ determines the progressive video signal S′ changes into a normal video signal from a film mode video signal or the progressive video signal S′ is a normal video signal, the second video processing module 305 decreases the decision threshold of exiting the film mode when executing the second video detection, so as to enter the normal mode more easily.

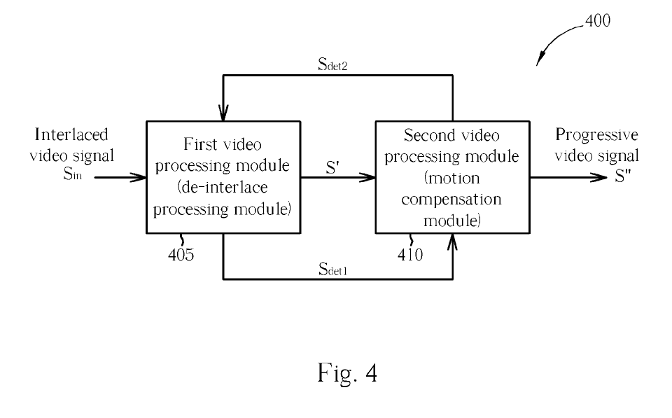

FIG. 4 is a block diagram of a video processing apparatus 400 according to a third embodiment of the present invention. A video processing module of this embodiment is capable of utilizing information related to the video detection result of other video processing module. As shown in FIG. 4, a first video processing module 405 executes a first video detection for a first video processing operation by referencing a detection result S_{det2} of a second video detection, and a second video processing module 410 executes the second video detection according to a detection result S_{det1} of the first video detection for a second video processing operation. One of the first and second video detections is a line-based detection, and the other is a block-based detection. For instance, in this embodiment, the first video processing module 405 is a de-interlace processing module and the second video processing module 410 is a motion compensation module; the first video detection is a line-based video detection and the second video detection is a block-based video detection.

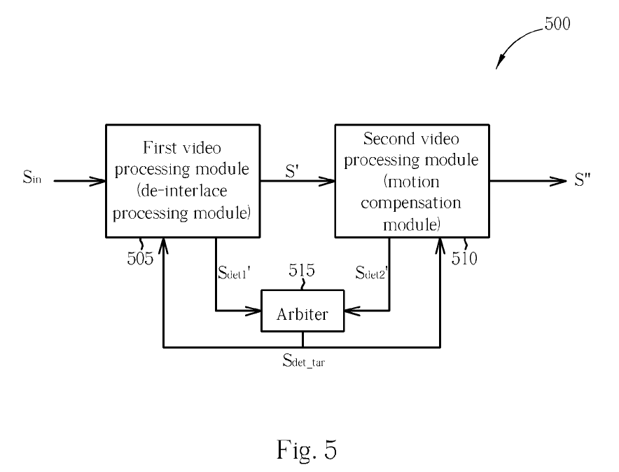

Furthermore, in another embodiment, an arbiter (e.g. a central controller) can aid determining a target detection result according to detection results of a line-based video detection and a block-based video detection. Please refer to FIG. 5. FIG. 5 is a block diagram of a video processing apparatus 500 according to a fourth embodiment of the present invention. The video processing apparatus 500 comprises a first video processing module 505 (e.g. a de-interlace processing module), a second video processing module 510 (e.g. a motion compensation module), and an arbiter 515. The first video processing module 505 executes a first video detection (i.e. a line-based video detection) required by a first video processing operation, and the second video processing module 510 executes a second video detection (i.e. a block-based video detection) required by a second video processing operation. The arbiter 515 then determines a target detection result S_{det}_{_{—tar}} according to a first detection result S_{det1}′ of the first video detection and a second detection result S_{det2}′ of the second video detection. In this embodiment, the first video processing module 505 and the second video processing module 510 respectively performs the first video processing operation (i.e. the de-interlace operation) and the second video processing operation (i.e. the motion compensation operation) according to the target detection result S_{det}_{_{—tar}}. In some other embodiments, the target detection result may only be used by one of the video processing modules. Those skilled in this art should appreciate that any modification of the arbiter 515 used for aiding a determination of the target detection result also falls within the scope of the present invention. Further description is omitted for brevity.

Moreover, it should be noted that the de-interlace processing modules and motion compensation modules in the above embodiments are only for illustrative purposes. These are not meant to be limitations of the present invention. In other embodiments, a first/second video processing module can be a noise reduction module or a comb filter, etc. In other words, no matter what a particular video processing operation is de-interlace processing, motion judder compensation, noise reduction, or comb filtering, etc, performing the particular video processing operation by using/referencing a result of video detection for a different video processing operation obeys the spirit of the present invention.

Those skilled in the art will readily observe that numerous modifications and alterations of the device and method may be made while retaining the teachings of the invention.

What is claimed is:

1. A video processing method, comprising:
executing a first video detection for a first video processing operation; and
referencing a detection result of the first video detection to perform a second video processing operation;
wherein one of the first and second video processing operations is line-based processing, and the other is block-based processing.

2. The video processing method of claim 1, wherein the first and second video detections are video motion detections or film mode detections.

3. The video processing method of claim 1, wherein one of the first and second video processing operations is a de-interlace operation, and the other is a motion compensation operation.

4. The video processing method of claim 1, further comprising:
executing a second video detection for the second video processing operation;
wherein the second video processing operation is conducted by referencing detection results of the first and second video detections.

5. The video processing method of claim 4, wherein the first video processing operation is conducted by referencing the detection results of the first and second video detections.

6. The video processing method of claim 1, further comprising:
executing a second video detection by referencing the detection result of the first video detection; and
conducting the second video processing operation utilizing a detection result of the second video detection.

7. The video processing method of claim 6, further comprising:
providing the detection result of the second video detection to execute the first video detection.

8. The video processing method of claim 6, wherein executing the second video detection by referencing the detection result of the first video detection further comprises:
referencing the detection result of the first video detection to adjust a decision threshold of entering or exiting a film mode.

9. The video processing method of claim 4, wherein executing the second video detection by referencing the detection result of the first video detection comprises referencing the detection result of the first video detection to dynamically adjust a decision threshold of a motion parameter.

10. The video processing method of claim 1, further comprising:
executing a second video detection for the second video processing operation;
determining a target detection result according to detection results of the first and second video detections; and
performing at least one of the first and second video processing operations according to the target detection result.

11. A video processing apparatus, comprising:
a first video processing module, executing a first video detection and performing a first video processing operation; and
a second video processing module, coupled to the first video processing module, performing a second video processing operation by referencing a detection result of the first video detection;
wherein one of the first and second video processing operation is line-based processing, and the other is block-based processing.

12. The video processing apparatus of claim 11, wherein the first and second video detections are video motion detections or film mode detections.

13. The video processing apparatus of claim 11, wherein one of the first and second video processing operations is a de-interlace operation, and one of the first and second video processing modules is a de-interlace processing module; and the other of the first and second video processing operations is a motion compensation operation, and the other of the first and second video processing modules is a motion compensation module.

14. The video processing apparatus of claim 11, wherein the second video processing module executes a second video detection.

15. The video processing apparatus of claim 14, wherein the second video processing module performs the second video processing operation based on detection results of the first and second video detections.

16. The video processing apparatus of claim 14, wherein the second video processing module executes the second video detection by referencing to the detection result of the first video detection.

17. The video processing apparatus of claim 16, wherein the second video processing module adjusts a decision threshold of entering or exiting a film mode by referencing the detection result of the first video detection.

18. The video processing apparatus of claim 16, wherein the second video processing module dynamically adjust a decision threshold of a motion parameter by referencing the detection result of the first video detection.

19. The video processing apparatus of claim 14, wherein the first video processing module executes the first video detection by referencing detection result of the second video detection.

20. The video processing apparatus of claim 11, further comprising:
an arbiter, coupled to the first video processing module and the second video processing module, determining a target detection result according to detection results of the first and second video detections;
wherein the first video processing module performs the first video processing operation by referencing the target detection result.

21. The video processing apparatus of claim 20, wherein the second video processing module performs the second video processing operation by referencing the target detection result.
